(19) United States
(12) Patent Application Publication
(10) Pub. No.: US 2007/0057011 A1
(43) Pub. Date: Mar. 15, 2007

(54) STAPLER

(75) Inventors: Balaji Kandasamy, Naperville, IL (US); Mark Harris, McHenry, IL (US); Yoshiyuki Ebihara, Toyko (JP); Yuki Hamaguchi, Toyko (JP)

Correspondence Address: MICHAEL BEST & FRIEDRICH, LLP, 100 E WISCONSIN AVENUE, MILWAUKEE, WI, 53202, US

(73) Assignee: ACCO BRANDS USA LLC, Lincolnshire, IL (US)

(21) Appl. No.: 11/424,618

(22) Filed: Jun. 16, 2006

(30) Foreign Application Priority Data
Jun. 17, 2005 (JP) 2005-177441

(51) Int. Cl. B25C 5/02

(52) U.S. Cl. 227/134

(57) ABSTRACT

A desktop stapler includes a base configured to rest on a support surface, a cover, and a magazine. The stapler further includes an elastic member, a driver blade, and a support member. The elastic member is positioned at least partially between the cover and magazine and stores energy applied to the cover as the cover is moved relative to the magazine. The driver blade is coupled to an end of the elastic member and is configured to push out staples from the magazine. The support member selectively engages the elastic member and energy is stored in the elastic member as the cover is moved relative to the magazine. The elastic member is engaged with a portion of the support member. Energy stored in the elastic member is released when the elastic member disengages from the portion of the support member, causing the driver blade to push out a staple.

### CROSS-REFERENCE TO RELATED APPLICATIONS

This application claims priority to Japanese Patent Application No. 2005-177441, filed Jun. 17, 2005, the entire contents of which are incorporated by reference herein.

### BACKGROUND

The invention relates to staplers, and more particularly, to staplers utilizing potential energy to assist in operating the staple drive mechanism. Potential energy or spring assisted office staplers have traditionally been of two types; either a stationary adaptation of powerful tacker-type models or a stationary stapler whose spring assist cannot achieve full power to drive and clinch the required sheet capacity without additional user applied force.

Typically, in a tacker-type stapler the staples are driven into the target object but the leg of staples are not bent. The strong force that is required for driving the staples is obtained by releasing the pressure that is accumulated in a spring or elastic member. Further, this structure that stores pressure in the spring can be of many different types but all are typically structured such that when the stapler is not in operation, the blade is located in front of the staples and when the blade is lifted, the staples move forward in the magazine. The blade is then lowered to drive one of the staples that has been pushed forward. This entire series of operations are executed in one instant with a powerful flow of force. Such a tacker is illustrated in U.S. Pat. No. 6,145,728. A stationary stapler adaptation of a similar mechanism is illustrated in U.S. Pat. No. 6,918,525.

In this type of tacker-type stapler configuration, when nothing is being stapled, there is a danger of staples flying out of the tacker inadvertently and it was necessary to develop a more complex structure in order to prevent such erroneous operations. Further, what is then seen in the tacker-type is a stationary configuration which requires loading the stapler from the rear due to the driver being in front of the staples and not lifted except during stapler operation. As a result, when the staples are reloaded, either the base or the magazine frame would have to be rotated and opened and the staples would then be fed. As such, more complex structures were adopted for each of inadvertent operation and staple reloading.

In the second type, spring assisted power has been applied within stationary staplers with a raised driver and without rear staple loading. However, previous approaches achieved very limited power gain given the limitations of known spring trigger mechanisms, known driver engagement mechanisms or other related linkages. These constructions only partly automate the function of the stapler and require additional manual force be applied to the driver when a stapler is operated at its sheet capacity, otherwise the staple would not be fully clinched under the paper. A stationary stapler adaptation of such an assist mechanism is illustrated in U.S. Pat. No. 5,356,063.

Both known types utilize locking mechanisms which act directly on the driver blade. These locking mechanisms intermittently experience functional problems including reduced power transmission to the driver, premature component failure, unreliable actuation and difficulty in returning to the rest position.

### SUMMARY

This invention is a stapler that is used for binding together the target objects by driving the staples utilizing the force that has been accumulated in an elastic member, that iorce being released all at once. The invention is also related to a stapler where the driver blade is not positioned in front of the staples but rather above the staples when the stapler is not in use. Further, this invention fully automates the function of the stapler while achieving adequate power and maintaining the preferred loading method.

The invention could be utilized in a desktop-type stapler, where the staple legs are bent to bind together the target objects, or a tacker-type stapler where the staple legs are not bent. The desktop-type stapler of this invention reduces the possibility of the staples flying out by mistake and aims to obtain a stapling action that staples with a lot of power. Further, this is a stapler that is used for binding together papers and the like. The force that has been accumulated in the elastic object material is fed into the structure of the tacker from the viewpoint of releasing the force that has been stored up in the elastic member all at once and, as mentioned, it does not have a composition that is usually seen in tackers wherein the blade is located in front of the staples, but rather a structure where the blade is positioned above the staples.

Further the invention also aims to achieve a structure whereby there is no need for a large rotation or movement of the base or the frame when the staples are being reloaded. The invention also aims to have a function where not only will the staples not be ejected by mistake, but further the structure will be simple and the stapling operation can be performed with a light force.

In one embodiment, the invention provides a desktop stapler that includes a base configured to rest on a support surface, a cover coupled to the base, and a magazine coupled to the base and the cover and configured to house staples. The stapler further includes an elastic member, a driver blade, and a support member. The elastic member is positioned at least partially between the cover and the magazine and stores energy applied to the cover as the cover is moved relative to the magazine. The driver blade is coupled to an end of the elastic member and configured to push out staples from the magazine. The support member selectively engages the elastic member. Energy is stored in the elastic member as the cover is moved relative to the magazine. The elastic member is engaged with a portion of the support member, and energy stored in the elastic member is released when the elastic member disengages from the portion of the support member, causing the driver blade to push out a staple. In one embodiment, the support member selectively engages the elastic member without directly contacting the driver blade thus eliminating many of the attendant locking mechanism problems.

In another embodiment, the invention provides a desktop stapler that includes a base configured to rest on a support surface, a cover coupled to the base, and a magazine coupled to the base and the cover and configured to house staples. The stapler further includes a leaf spring, a driver blade and a support member. The leaf spring is positioned at least partially between the cover and the magazine and that stores energy applied to the cover as the cover is moved relative to the magazine. The leaf spring has at least a portion formed with two layers. The driver blade is coupled to an end of the leaf spring and is configured to push out staples from the magazine, and the support member selectively engages the leaf spring. Energy is stored in the leaf spring as the handle or cover is moved relative to the magazine and the leaf spring is engaged with a portion of the support member. Energy stored in the leaf spring is released when the leaf spring disengages from the portion of the support member, causing the driver blade to push out a staple.

In some embodiments of the invention, the engagement part of the elastic member is engaged with a support member in the form of a slider, and as the cover and the frame come closer together due to the force input on the cover, the engagement part moves along the upper surface of the slider relatively until the engagement between the elastic member and the slider is released with the engagement part passing through the front end of the top surface of the slider. The slider is movable relative to the magazine in the forward and backward directions (i.e., longitudinally). In other configurations, the support member can take the form of a pivoting member attached in the frame and rotatable about a pivot axis.

In other embodiments of the invention, the slider includes a taper or arcuate surface in the front end of the slider, and the upper surface angle protrudes even farther out than a lower surface angle. With the cover and the frame coming closer together, the engagement part provides force such that the slider's upper surface front end is moved, leading to a disengagement of the elastic member and the slider. With a release of the force that is applied in a direction that brings the cover and the frame close together, the cover rises upwards and the engagement part of the elastic member rises along the taper or arcuate surface. Once the rising has been completed, the engagement part is engaged with the upper surface of the slider and with the help of the slider spring, the engagement portion of the engagement part and the slider are tilted in the direction that pushes the slider in the backward direction. With the engagement part pushing the upper surface of the slider back, the elastic member returns to the configuration that exists when the stapler is not in use.

In some embodiments of the invention, the stapler includes a means that helps in disengaging the elastic member and the slider. The slider is pushed back with respect to the frame due to engagement between the cover and the slider.

Typical potential energy stapler technology utilizes a portion of the frame to prevent the driver blade from extending out of the bottom of the magazine. Preventing the driver blade from extending out of the magazine reduces the stapling power and can generate a considerable amount of noise. The stapling force is reduced because the driver blade is suddenly stopped during stapling. Therefore, more force needs to be generated by the stapler than the actual force that is required for stapling because energy is consumed to prevent the driver blade from extending out of the magazine.

The driver blade of the stapler of the present invention is allowed to extend out of the magazine during stapling. Thus, there is generally no need to stop the blade from extending past the bottom of the magazine. As a result, less force needs to be generated by the stapler of the present invention versus typical potential energy staplers because energy is not consumed to stop the driver blade. Therefore, comparing the stapler of the present invention with typical potential energy staplers, the current stapler can staple the same amount of sheets or other items with less force. In addition, the stapler of the present invention generates less noise than typical potentially energy staplers because the driver blade is not suddenly stopped.

Since the blade starts from above the staples, a front-loading mechanism or arrangement can still be used. Further the stapler of the present invention provides a stapler with potential energy technology while only slightly increasing the number of component parts from non-potential energy type staplers.

The elastic member coupled to the underside of the cover creates a compact design such that the space required for the working components is less than staplers with other types of potential energy technology. When this feature is added to the fact that the number of parts is less, the freedom in the design is greatly enhanced and it is easy to construct this device such that it is more compact than staplers with other types of potential energy technology.

Further, it is possible to change the force provided by the plate spring by making changes to the plate thickness and configuration, and has therefore becomes easier to apply this new technology over a wide range of devices starting from small staplers that require only minimal amount of force for stapling and extending to large staplers that need more force for the stapling action.

A stapler with other potential energy technology needs to have various safety measures and features to facilitate reloading the staples. The driver blade in the present invention is initially at rest above the staples and there is no spring force in the blade. Therefore, it is easy to obtain the same level of safety as a conventional stapler when reloading the staples.

Other features and advantages of the invention will become apparent to those skilled in the art upon review of the following detailed description, claims, and drawings.

### DESCRIPTION OF THE DRAWINGS

FIG. 1 is an external view of the stapler embodying the present invention.

FIG. 2 is a cutaway view of the stapler of FIG. 1, illustrating the internal configuration of the stapler when the stapler is not in use.

FIG. 3 is an exploded view of a portion of the stapler of FIG. 2.

FIG. 3a is an enlarged view of an elastic member of the stapler illustrated in FIG. 3.

FIG. 4 is a perspective view of a staple magazine of the stapler of FIG. 1 when the magazine of the stapler is pulled out.

FIGS. 5a-5e illustrate the operation of the stapler of FIG. 1.

FIGS. 5a′-5e′ relate to FIGS. 5a-5e respectively and illustrate a portion of the stapler of FIG. 1 during the operation of the stapler.

FIG. 6 illustrates the internal configuration of the stapler of FIG. 1 when the stapler is being operated just before a staple is driven from the stapler.

FIG. 7 illustrates the internal configuration of the stapler of FIG. 1 when the stapler is being operated after the staple is driven from the stapler.

FIG. 8 illustrates the internal configuration of the stapler of FIG. 1 when the stapler is being operated as the cover begins to rise with respect to the staple magazine.

FIG. 9 illustrates the internal configuration of the stapler of FIG. 1 when the stapler is being operated as the cover continues to rise with respect to the staple magazine.

FIG. 10 illustrates the internal configuration of the stapler of FIG. 1 when the stapler has returned to the rest or start position.

FIG. 11 illustrates the inner configuration of the stapler of FIG. 1 when the magazine of the stapler is pulled out to extend from the stapler

FIG. 12 is an alternative embodiment of the stapler of FIG. 1 illustrating the inner configuration of the stapler and a driver spring.

FIG. 12a illustrates the driver spring of the stapler of FIG. 12.

FIG. 13 is another alternative embodiment of the stapler of FIG. 1 illustrating the inner configuration of the stapler and a driver spring.

FIG. 13b illustrates the driver spring of the stapler of FIG. 13.

FIG. 14 is yet another alternative embodiment of the stapler of FIG. 1 illustrating the internal configuration of the stapler.

FIG. 15 is yet another alternative embodiment of the stapler of FIG. 1 illustrating the inner configuration of the stapler when the stapler is in the rest or start position.

FIG. 16 illustrates the stapler of FIG. 15 when the stapler is being operated just before a staple is driven from the stapler.

FIG. 17 illustrates an elastic member of the stapler of FIG. 15.

FIG. 18 illustrates a support member of the stapler of FIG. 15.

FIG. 19 is an enlarged view of a front portion of the stapler of FIG. 15 with a portion of the stapler removed.

FIG. 20 is yet another alternative embodiment of the stapler of FIG. 1 illustrating the inner configuration of the stapler when the stapler is in the rest or starting position.

FIG. 21 illustrates the stapler of FIG. 20 when the stapler is being operated just after a staple has been driven from the stapler.

FIG. 22 illustrates the stapler of FIG. 20 when the stapler is being operated as the cover rises back to the starting position.

FIG. 23 is yet another alternative embodiment of the stapler of FIG. 1 illustrated the inner configuration of the stapler when the stapler is in the rest or starting position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The present invention will be described with reference to the accompanying drawings figures wherein like numbers represent like elements throughout. Certain terminology, for example, “up”, “down”, “right”, “left”, “clockwise”, “counterclockwise” is used in the following description for relative descriptive clarity only and is not intended to be limiting.

### DETAILED DESCRIPTION

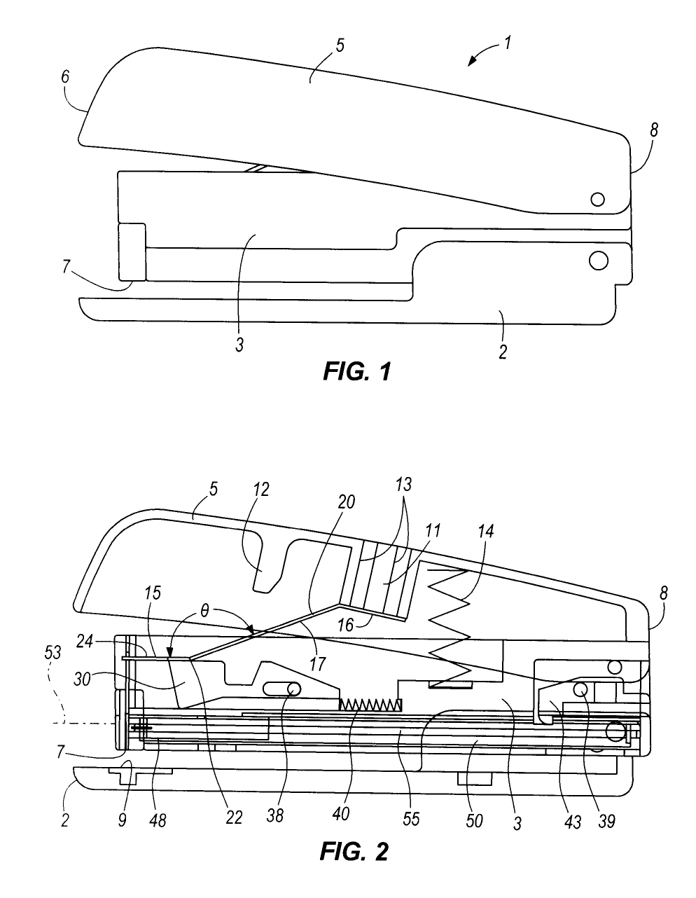

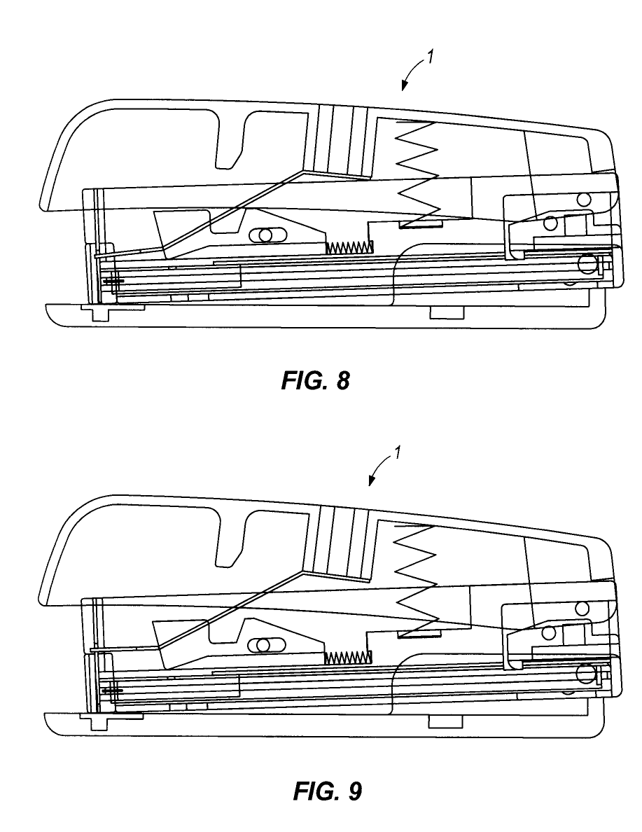

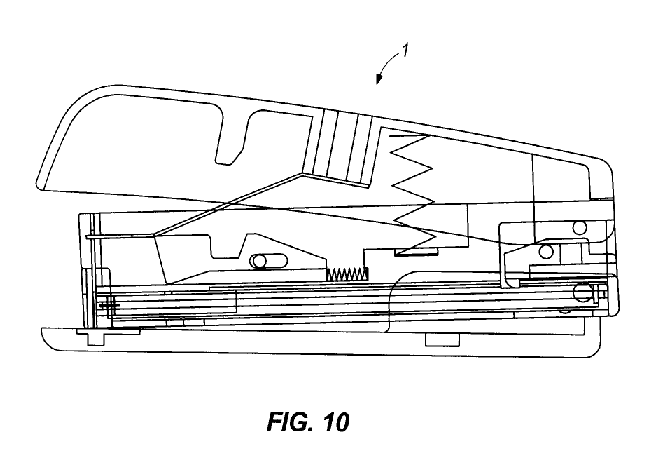

A first embodiment of a stapler 1 is illustrated in FIGS. 1-11. The external appearance of the stapler 1 is as seen in FIG. 1. Referring to FIGS. 1 and 2, the stapler 1 defines a front end 6, adjacent a staple ejection location 7, and a rear end 8 opposite the front end 6. The stapler 1 includes a base 2, a frame 3 that is coupled to the base 2, and a handle or cover 5 that is coupled to the frame 3 near the rear end 8 of the stapler 1.

The illustrated base 2 includes an anvil 9. As is understood by one of skill in the art, the anvil 9 facilities clinching or bending staples. The base 2 supports the stapler 1 on a support surface, such as a desk, table, countertop, and the like.

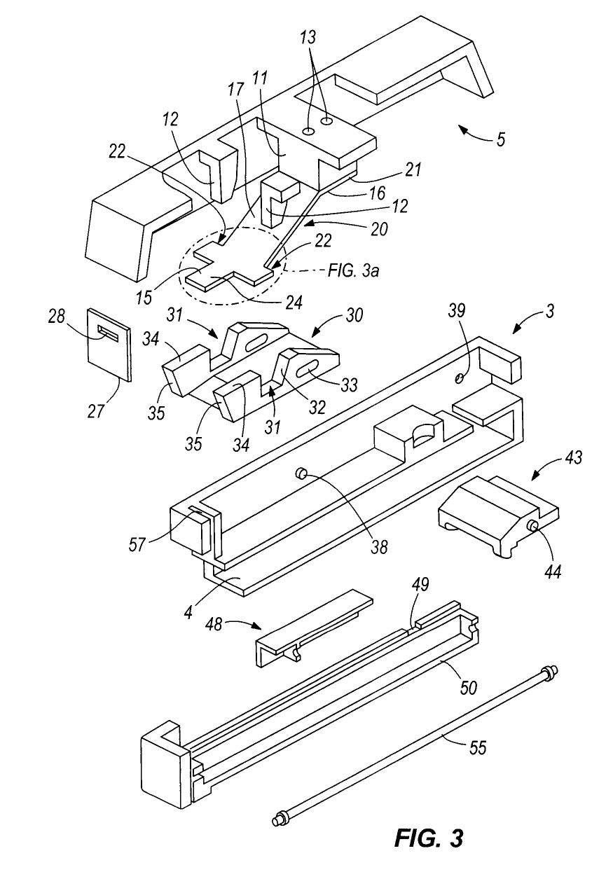

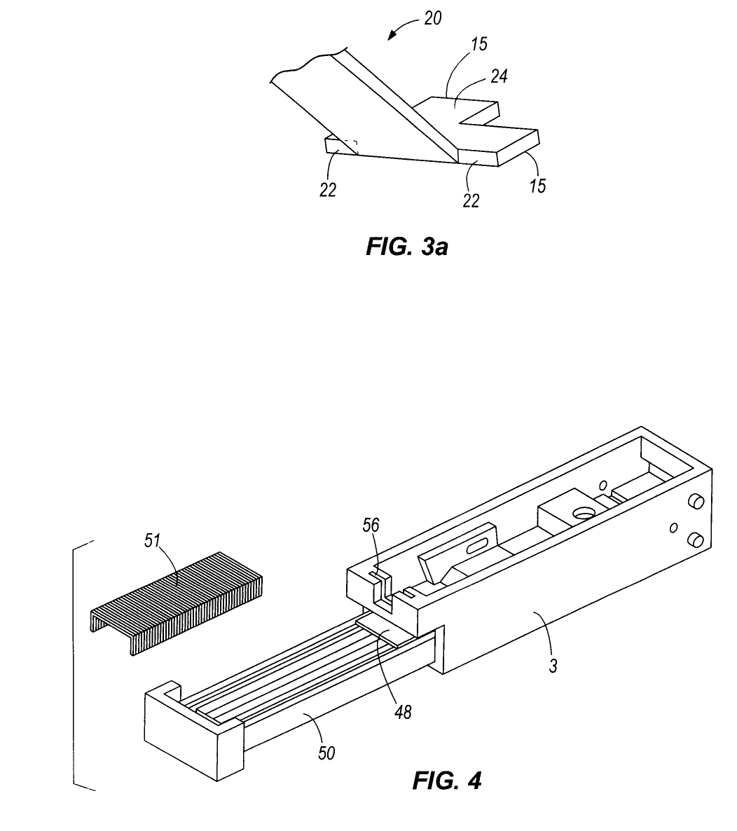

FIG. 2 illustrates the internal configuration of the stapler 1 when the stapler 1 is not in operation. FIG. 3 is an exploded view that illustrates several of parts of the stapler 1. For clarity, FIG. 3 is a cross-sectional view along a longitudinal axis of the stapler 1 illustrating generally half of several parts of the stapler 1.

Referring to FIGS. 1-3, the illustrated stapler 1 further includes a cover biasing member 14 between the cover 5 and the frame 3 that biases the cover 5 away from the frame 3. While, the illustrated cover biasing member 14 is a coil spring, in other constructions the cover biasing member can be any suitable spring, such as torsion springs, leaf springs, and the like, or other suitable biasing members.

The illustrated cover 5 includes a trigger member 12 that extends from an inside surface of the cover 5. While the illustrated trigger member 12 includes two projections, in other constructions the trigger member can include only a single projection or may take other suitable forms. The cover 5 further includes a spring or elastic member receiver portion 11 that extends from the inside surface of the cover 5, adjacent the trigger member 12.

The stapler 1 further includes a driver member or elastic member 20, which is a leaf spring in the illustrated construction. The elastic member 20 is positioned between the cover 5 and the magazine 50. The elastic member 20 includes a first or free end portion 15, a second or fixed end portion 16, and a body portion 17 that extends between the free and fixed end portions 15, 16. The fixed end portion 16 of the illustrated elastic member 20 includes a substrate or base portion 21 that is utilized to couple the elastic member 20 to the receiver portion 1 of the cover 5. In the illustrated construction, the elastic member 20 is coupled to the cover 5 using fasteners that extend into apertures 13 formed in the cover 5. In other constructions, a slit can be provided in the receiver portion 11, or at any suitable location within the cover 5, and at least a portion of the base portion 21 of the elastic member 20 can be bent to form a tab such that the tab can be press-fitted into the slit of the cover. Such a tab and slit configuration construction can be used alone or in combination with fasteners and the apertures 13.

Referring to FIGS. 3 and 3a, the free end 15 of the elastic member 20 includes a blade engagement portion 24 and a slider or support member engagement portion 22 that extends in a lateral direction from the blade engagement portion 24 to form a T-shaped engagement portion of the elastic member 20 in the illustrated embodiment. A driver blade 27 is coupled to the elastic member 20 at the blade engagement portion 24. The blade engagement portion 24 of the elastic member 20 extends through a slit 28 formed in the driver blade 27 to couple or engage the elastic member 20 to the driver blade 27. The slit 28 of the driver blade 27 is sized such that the blade engagement portion 24 of the elastic member 20 is free to move with respect to the driver blade 27 in the forward and rearward directions.

Referring to FIG. 2, in the illustrated construction the elastic member 20 is a leaf spring. In other constructions, the elastic member 20 can be any suitable biasing member. The leaf spring defines an angle θ that is measured from the blade engagement portion 24 to the body portion 17 of the elastic member 20 with the stapler 1 in a resting or starting position (i.e., the cover 5 has not been pushed down). In the illustrated construction, the angle θ is approximately 160 degrees. In other constructions, the angle θ can be more or less than 160 degree depending on the application of the stapler 1. For example, if the stapler 1 is designed for relatively large staples and/or to staple through a relatively large amount of paper and the like, the angle θ can be less than 160 degrees.

Referring to FIGS. 2 and 3, the stapler 1 further includes a support member 30, which is a slider in the illustrated construction. The support member 30 includes cut out portions 31 that define trigger guide surfaces 32, and support surfaces 34 that slidably support the support member engagement portions 22 of the elastic member 20. The support member 30 further includes spring guide openings or slots 33 that extend transversely through the support member 30 and front tapered portions or surfaces 35 that are spaced a distance apart in order to engage the support member engagement portions 22 of the elastic member 20.

The illustrated support member 30 is coupled to the frame 3 using hubs or bosses 38 (only one visible in FIG. 3) that are received by the slots 33 of the support member 30. The illustrated support member 30 is able to slide with respect to the frame 3, and the slots 33 define the maximum forward and rearward positions of the support member 30 with respect to the frame 3. In the illustrated construction, the support member 30 slides is a direction generally parallel to a longitudinal axis 53 defined by the magazine 50 of the stapler 1. As best illustrated in FIG. 2, a biasing member 40, which is a coil spring in the illustrated construction, biases the support member 30 toward the front end 6 of the stapler 1.

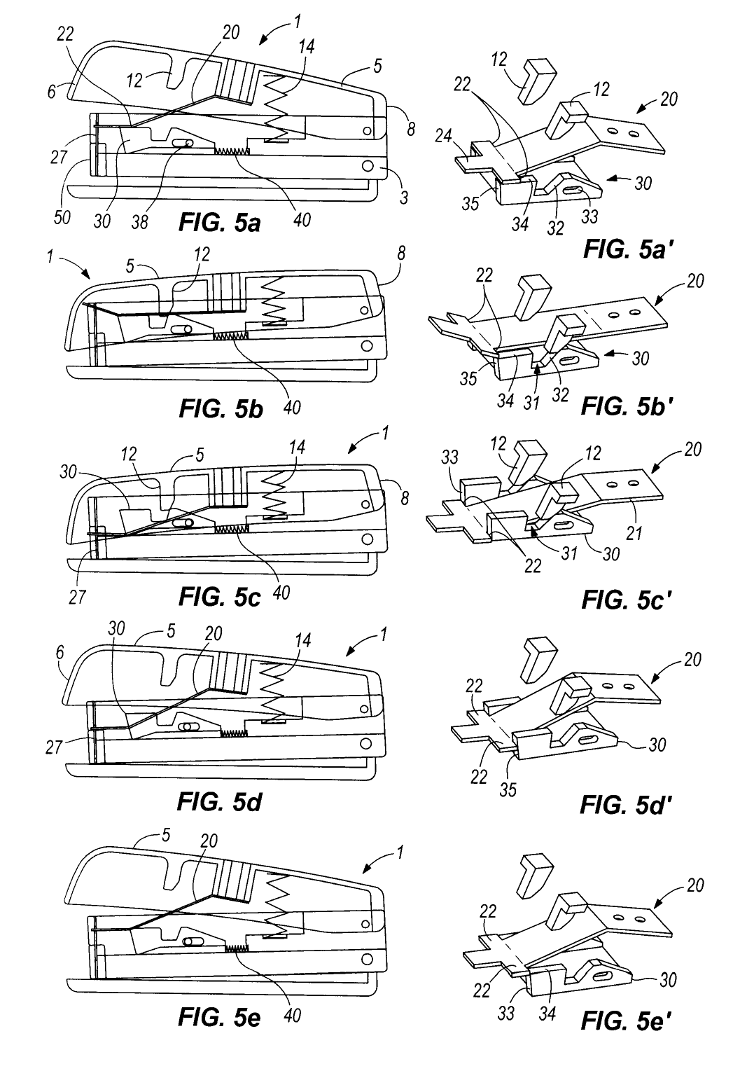

Referring to FIGS. 5a and 5a′, when the stapler 1 is not in operation, the support member engagement portion 22 of the elastic member 20 is positioned on or above the spring gliding part or support surface 34 of the slider 30. Although the slider 30 moves with respect to the frame 3 in the forward and the rearward directions, the movement of the slider 30 is limited due to the engagement between the hub 38 of the frame 3 and the spring guide opening or slot 33 of the slider 30. Referring to FIG. 5a, the slider spring or biasing member 40 moves or biases the slider 30 in the forward direction (i.e. toward the front end 6 of the stapler 1).

Referring to FIGS. 2-4, the stapler 1 includes the magazine 50 that is housed in the area 4 of the frame 3. The magazine 50 stores or houses staples 51. The magazine 50 is located with respect to the frame 3 such that a driver blade slot 56 formed in the magazine 50 is aligned with a driver blade slot 57 formed in the frame 3. The drive blade slots 56, 57 of the magazine 50 and the frame 3 are aligned such that the driver blade 27 can pass freely through both of the slots 56, 57.

Referring to FIG. 3, the illustrated magazine 50 includes a feeder or staple pusher 48 and a guide rod 55. The staple pusher 48 moves along the guide rod 55 to move or push staples 51 toward the front end 6 of the stapler 1. While not illustrated, the magazine 50 can include a biasing member, such as a coil spring disposed around the guide rod 55 and coupled to the guide rod 55 and staple pusher 48 to bias the staple pusher 48 toward the front end 6 of the stapler 1. Other configurations can also be used to bias the staple pusher 48 toward the front end 6.

The magazine 50 further includes a hook or latch 43 and a cut out 49. The latch 43 includes mounting bosses 44 (only one visible in FIG. 3) that couple the latch 43 to the frame 3 using the apertures 39 (only one visible in FIG. 3) formed within the frame 3. The bosses 39, 43 facilitate a pivoting connection of the latch 43 to the frame 3. While not illustrated a biasing member, such as a spring, can be used to bias the latch 43 into an engaged position, such that the latch 43 is engaged with the cut out 49.

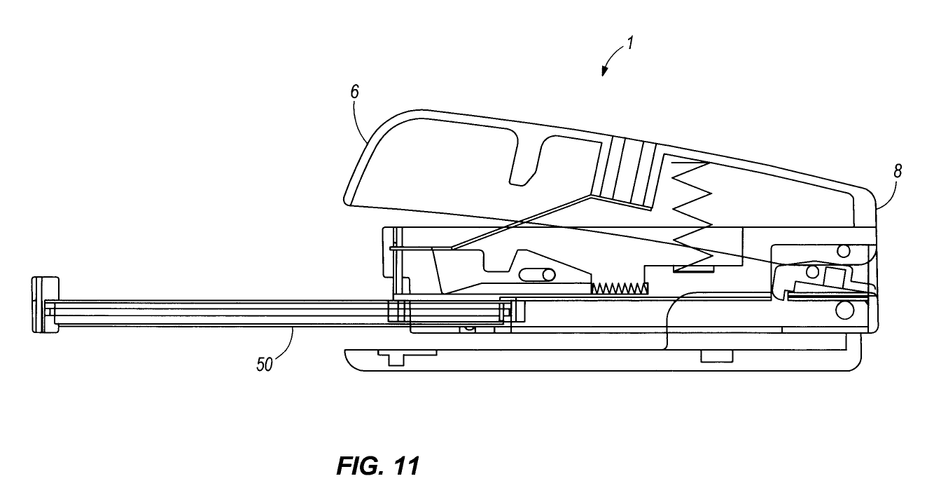

While not illustrated, the magazine 50 further includes a magazine biasing member, such as a spring, that biases magazine 50 toward an open position (FIG. 11) or from the rear end 8 of the stapler 1 toward the front end 6. By disengaging the latch 43 from the cut out 49, it is possible to draw out or eject the magazine 50 forward for reloading staples 51 into the magazine 50 (FIG. 4). The user can disengage the latch 43 from the cut out 49 with a button, lever, or other suitable actuator interconnected to latch 43. In other constructions, the stapler 1 can be configured such that user can depress or push a rear portion of the latch 43 to eject the magazine 50 from the frame 3.

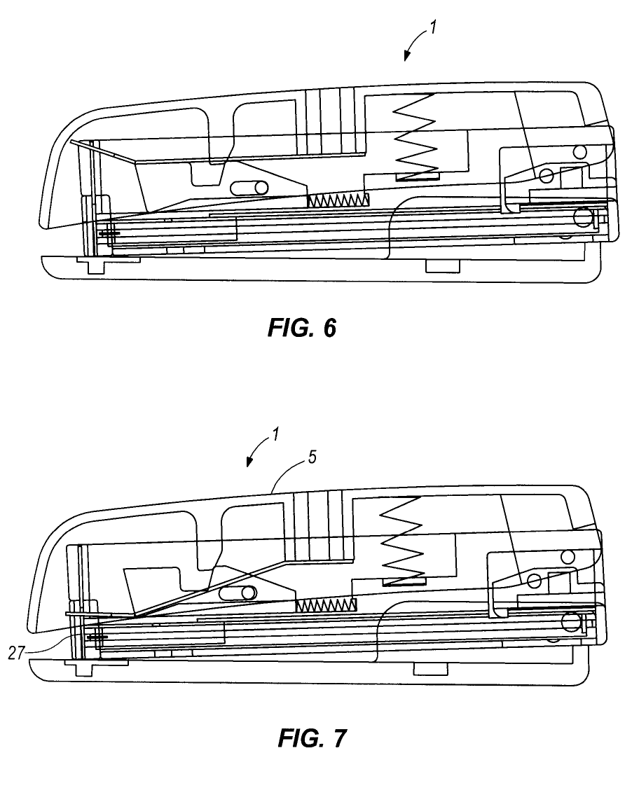

FIGS. 5a-5c illustrate the operation of the stapler 1 and the passage or ejection of the staples 51 (FIG. 4). By pushing the cover 5 downward, toward the magazine 50, the stapler 1 is operated in the order illustrated in the order FIG. 5a FIG. 5b FIG. 5c. The stapling operation is completed when the state shown in FIG. 5c is reached. To continue, when the user stops pushing the cover 5 downward, the stapler 1 returns to the state that existed (i.e., original or starting position) before stapling by carrying out the operations illustrated in the order FIG. 5d FIG. 5e FIG. 5a. The engagement of the elastic member 20, the support member 30 and the trigger member 12 is shown in the steps illustrated in FIGS. 5a′-FIG. 5e′. Details of the position illustrated in FIG. 5a are shown in FIG. 2 while the details of the position illustrated in FIG. 5b are shown in FIG. 6. FIGS. 7, 9 and 10 indicate the details of the positions illustrated in FIGS. 5c, 5d and 5e respectively.

As illustrated in FIGS. 5a and 5a′, when the user starts to push the cover 5 downward, toward the magazine 50, the engagement portion 22 of the elastic member 20 is in contact with the top surface or support surface 34 of the support member 30. When the cover 5 is pushed down further, the angle θ (FIG. 2) between the blade engagement portion 24 and the body portion 17 of the elastic member 20 is opened or the angle θ increases and the engagement portion 22 of the elastic member 20 moves forward along the support surface 34 of the support member 30.

As illustrated in FIGS. 5b and 5b′, if the cover 5 is pushed further down, the engagement portion 22 of the elastic member 20 will slide along the support surface 34 of the support member 30 right up to the front edge of the support surface 34. At this time, a large amount of force or energy to return to the original state (FIG. 5a) is accumulated in the elastic member 20.

As illustrated in FIGS. 5c and 5c′, should the cover 5 be pushed further down, the engagement portion 22 of the elastic member 20 will fall downward after detaching or disengaging from the support surface 34 of the support member 30. In the illustrated construction, the elastic member 20 passes through a portion of the support member 30 between upstanding portions that define the support surfaces 34. When the engagement portion 22 of the elastic member 20 disengages the support surface 34 of the support member 30, the driver blade 27 that is engaged with blade engagement portion 24 of the elastic member 20 is driven downward. The force that is accumulated in the elastic member 20 will be released instantly and the force driving the blade 27 will be sufficient to drive the staples effectively.

As illustrated in FIGS. 5b and 5b′ and in FIGS. 5c and 5c′, the trigger member 12 is lowered along with the cover 5, and the trigger member 12 is engaged with the trigger guide 32 while the trigger member 12 is fed into the cut out 31 of the support member 30. The trigger member 12 contacts the trigger guide surfaces 32 of the support member 30 and guides or pushes the support member 30 backward while the cover 5 moves down. In the illustrated construction, when the trigger member 12 contacts the support member 30 the user continues to push down on the cover 5 to overcome the force of the biasing member 40 to slide the support member 30 toward the rear end 8 of the stapler 1.

The trigger 12 facilitates disengaging the engagement portion 22 of the elastic member 20 from the tip or front edge of the support member 30. In other words, since the elastic member 20 is a plate or leaf spring, there is a small amount of bending of the elastic member 20 based on the timing or speed of the stapling action. Due to this bending, the distance from the base 21 of the elastic member 20 to the engagement portion 22 becomes shorter causing cases when the disengagement of the engagement portion 22 with the support member 30 does not occur properly. The support member 30 is then pushed backward or toward the rear end 8 of the stapler 1 by the trigger member 12 to ensure that the engagement portion 22 of the elastic member 20 is disengaged from the support member 30 and that the driver blade 27 falls.

FIGS. 5c and 7 illustrate the cover 5 of the stapler 1 in the furthest downward (i.e., lowered) position. As illustrated in FIGS. 5a-5c, as the cover 5 travels from the starting position (FIG. 5a) to the lowered position (FIG. 5c), the elastic member 20 extends through the slit 28 in the driver blade 27 (FIG. 3) to remain in continuous contact with the driver blade 27.

As illustrated in FIGS. 5c and 7, in the illustrated construction, the cover 5 does not contact the driver blade 27 when the cover 5 is in the lowered position. Therefore, when the cover 5 is the lowered position, the cover 5 generally does not tend to push the driver blade 27 further downward. Thus, the maximum achievable stapling power of the stapler 1 is generated by the elastic member 20, and the user cannot push down further or harder on the cover 5 to force the driver blade 27 down further.

After stapling, when the force used to push the cover 5 is released, the cover 5 returns to the original position (FIG. 5a) by rising immediately with the help of the cover biasing member 14. As shown in FIG. 5c′, in the illustrated construction, the trigger member 12 and the support member 30 are engaged only above the cut out 31 of the support member 30 when the cover 5 is in the lowered position. As the cover 5 rises, disengagement between the trigger member 12 and the support member 30 can take place easily and there is no longer any impact of the trigger member 12 on the support member 30.

As illustrated in FIGS. 5d and 5d′, as the cover biasing member 14 raises the cover 5, the engagement portion 22 of the elastic member 20 rises upward and is guided by the front taper portions 35 of the support member 30. At this time, the spring force of the cover biasing member 14, which forces the cover 5 and elastic member 20 to rise, is greater than the spring force of the biasing member 40 of the support member 30 that biases the support member 30 toward the front end 6 of the stapler 1. Because the front taper 35 angles forward, as the elastic member 20 rises, the engagement portion 22 not only slides along the front taper 35 of the support member 30, but also guides or pushes the support member 30 backward or toward the rear end 8 of the stapler 1.

As illustrated in FIGS. 5e and 5e′, as the cover 5 and the elastic member 20 rise further, the engagement portion 22 of the elastic member 20 reaches the peak of the front taper portions 35 of the support member 30. When the cover 5 and elastic member 20 rise slightly more, the engagement portion 22 is detached from the front taper portion 35 of the support member 30 and the engagement portion 22 of the elastic member 20 re-engages with the support surface 34 of the support member 30. When the engagement portion 22 is detached from the front taper portion 35 of the support member 30, the support member 30 is pushed forward by the biasing member 40 while the engagement portion 22 slides along the support surface 34 of the support member 30 to return the support member 30 and elastic member 20 to the original or starting position as illustrated in FIG. 5a.

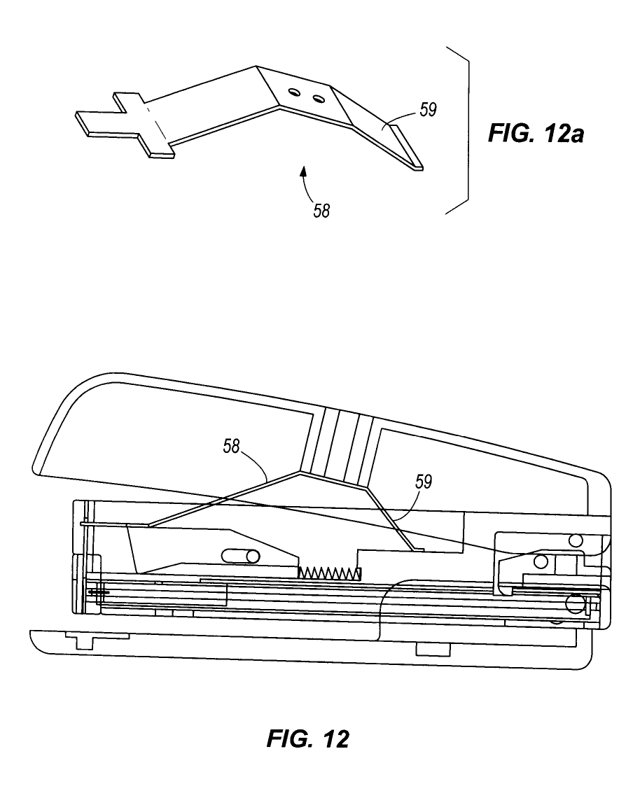

FIGS. 12 and 12a illustrate a second embodiment of the stapler. In the embodiment illustrated in FIG. 12, the elastic member 58 includes a rearwardly-extending plate spring portion 59 that functions as the cover biasing member (i.e., in place of the cover biasing member 14 of FIGS. 1-11). The illustrated plate spring portion 59 is integrally formed with the elastic member 58, however could be a separate piece. The other mechanisms of the stapler and operation of the stapler are similar to the first embodiment of FIGS. 1-11.

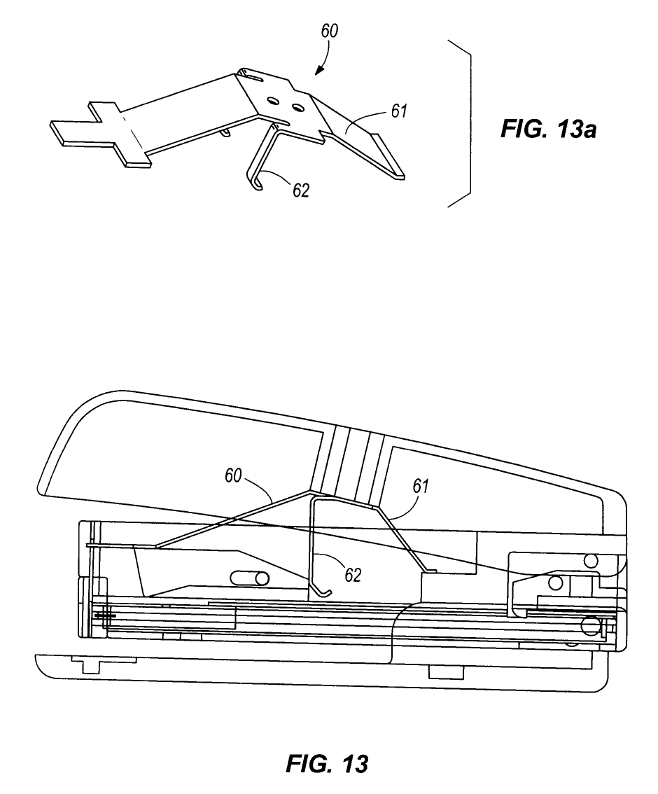

FIGS. 13 and 13a illustrate a third embodiment. The elastic member 60 includes a plate spring portion 61 that operates as the cover biasing member (i.e., in place of the cover biasing 14 of FIGS. 1-11). Furthermore, the elastic member 60 includes support member biasing members or slider springs 62 that can replace or supplement the biasing spring 40 of FIGS. 1-11. The illustrated slider springs 62 and plate spring 61 are integrally formed with the elastic member 60 but alternatively could be separate components. The other mechanisms of the stapler and operation of the stapler are similar to the first embodiment.

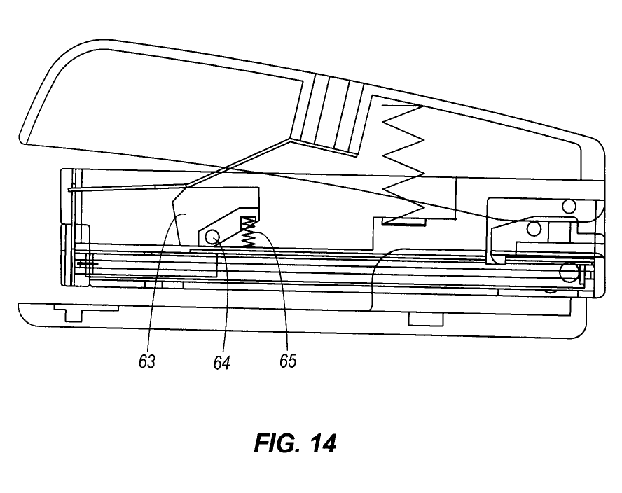

FIG. 14 illustrates a fourth embodiment in which the support member 30 is replaced by a cam 63 that guides the engagement part of the elastic member. The cam 63 rotates with the help of the cam spring 65 about the axis 64. The other mechanisms are similar to the first embodiment.

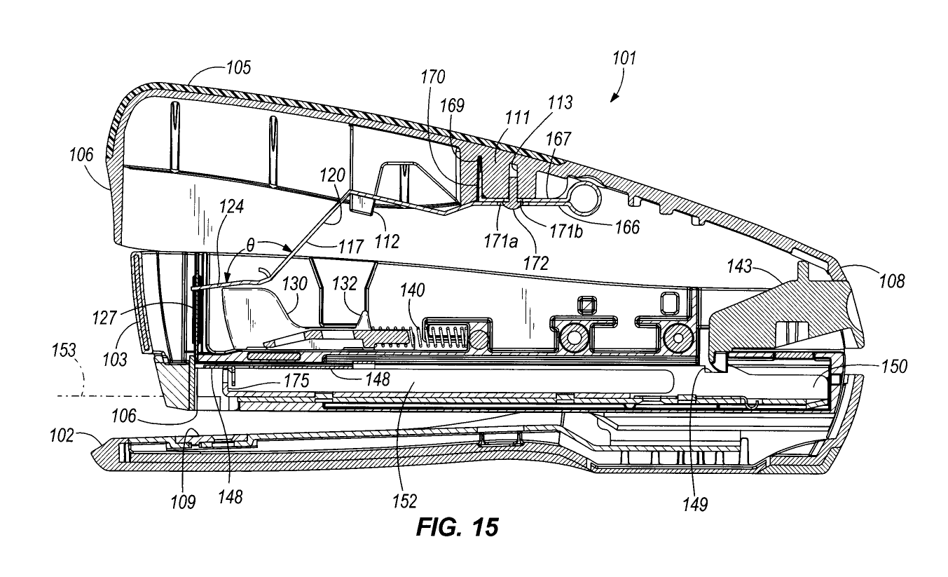

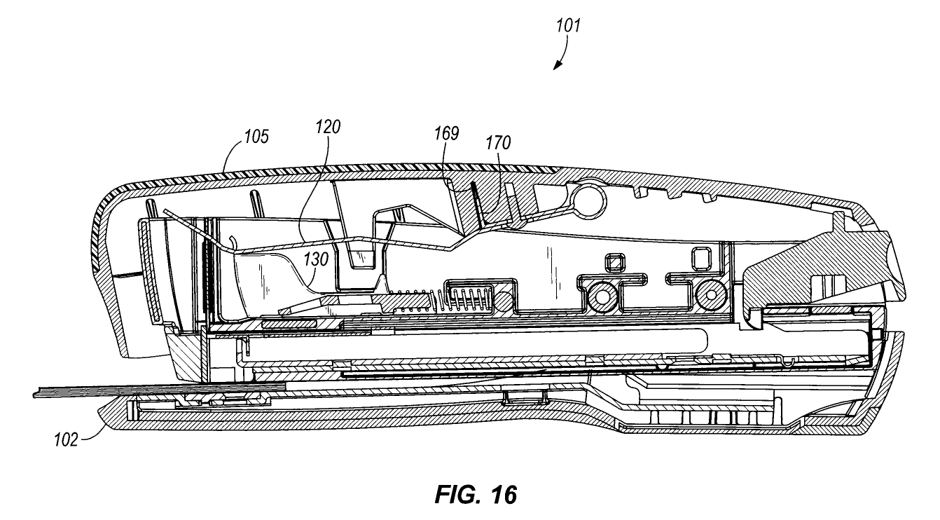

FIGS. 15-19 illustrate yet another alternative embodiment of the stapler 1 of FIGS. 1-11. The stapler 101 of FIGS. 15-19 is similar to the stapler 1 of FIGS. 1-11. Therefore, like components have been given like reference numbers in the one-hundred series, and only the general differences will be discussed below.

FIG. 15 illustrates the stapler 101 that includes the base 102, the frame 103 coupled to the base 102, and the cover 105 that is coupled to the frame 103.

The elastic member 120 is positioned between the cover 105 and the magazine 150. The illustrated elastic member 120 defines the angle θ between the body portion 117 and the driver blade engagement portion 124 that is approximately 140 degrees. As discussed above, the angle θ can be virtually any angle depending on the application of the stapler 101, including the angle θ that is approximately 160 degrees as illustrated in the stapler 1 of FIGS. 1-11.

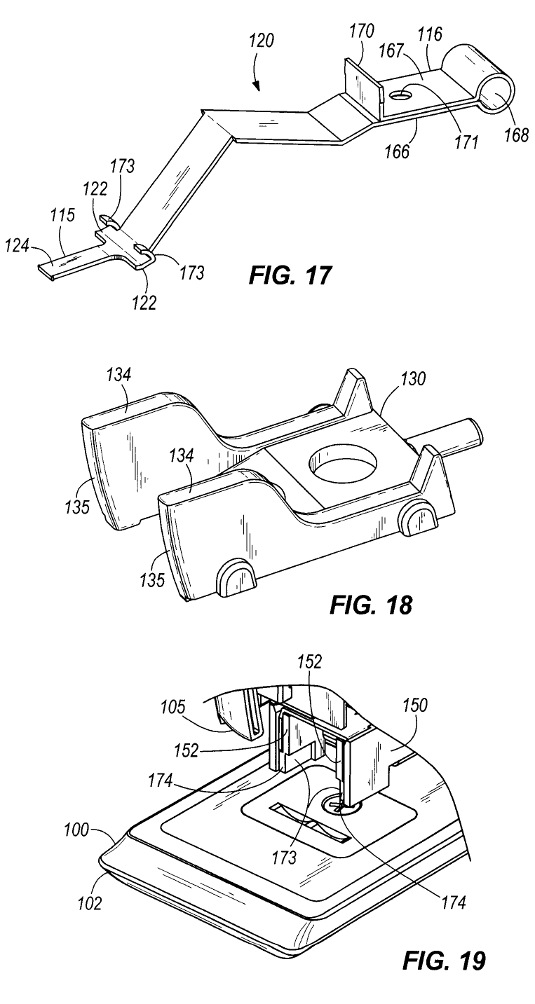

The elastic member 120 is illustrated in more detail in FIG. 17. The illustrated elastic member 120 is a leaf spring that includes the free or first end portion 115 and the fixed or second end portion 116. The second end portion 116 of the elastic member 120 includes a first layer 166 and a second layer 167. The first layer 166 and the second layer 167 are formed to define a loop 168. The illustrated first layer 167 of the elastic member 120 is bent generally upwards at one end to form a tab 170. The tab 170 is received within a slot 169 formed in the cover 105 to facilitate coupling the elastic member 120 to the cover 105.

Referring to FIGS. 15 and 17, the second end portion 116 of the illustrated elastic member 120 further includes an aperture 171 that extends through the elastic member 120. The aperture 171 receives a fastener 172 to couple the elastic member 120 to the cover 105. The illustrated aperture 171 includes a first aperture 171a formed through the first layer 166 and a second aperture 171b formed through the second layer 167 that is smaller than the first aperture 171a that extends through the first layer 166. The first and second apertures 171a, b are sized such that the second aperture 171b that extends through the second layer 167 is utilized to generally fix or secure the elastic member 120 to the cover 105 while the first aperture 171a that extends through the first layer 166 is larger than a head of the fastener 172. Therefore, the first aperture 171a and the first layer 166 are able to move with respect to the fastener 172 and the second layer 167. Such a configuration increases the effective length of the elastic member 120 as compared to the elastic member 20 of FIGS. 1-11 to include the first layer 166, the loop 168, and the portion of the second layer 167 between the loop 168 and the aperture 171b. However, it should be understood that any of the embodiments of the stapler described herein can include either the single layer elastic member or the dual layer elastic member.

Referring to FIG. 17, the first end portion 115 of the elastic member 120 includes the support member engagement portions 122. The illustrated support member engagement portions 122 define a generally T-shaped portion of the elastic member 120 and includes tabs 173 that are somewhat rounded. The tabs 173 facilitate sliding of the elastic member 120 along the front portions 135 of the support member 130 (FIG. 18).

Referring to FIGS. 15 and 18, the stapler 101 further includes the support member 130 that supports the elastic member 120. Similar to the support member 30 of FIGS. 1-11, the illustrated support member 130 of FIGS. 15 and 18 is a slider movable in a direction parallel to the longitudinal axis 153 of the magazine 150. The illustrated support member 130 includes support surfaces 134 that support the elastic member 120 and front end portions 135 that are both tapered and radiused. The radius of the front end portions 120 has been found to more effectively allow the elastic member 120 to move along the front end portions 135 to return to the support surfaces 134 of the support member 130 as the cover 105 rises after stapling.

Referring to FIG. 19, the illustrated magazine 150 of the stapler 101 includes the inner rails 152 that include swaged out end portions 173. The swaged out end portions 173 provide support surfaces 174 that stabilize or support the back of the staple when the staple is driven. The support surface 174 can be particularly beneficial for high speed and high sheet capacity staple driving applications.

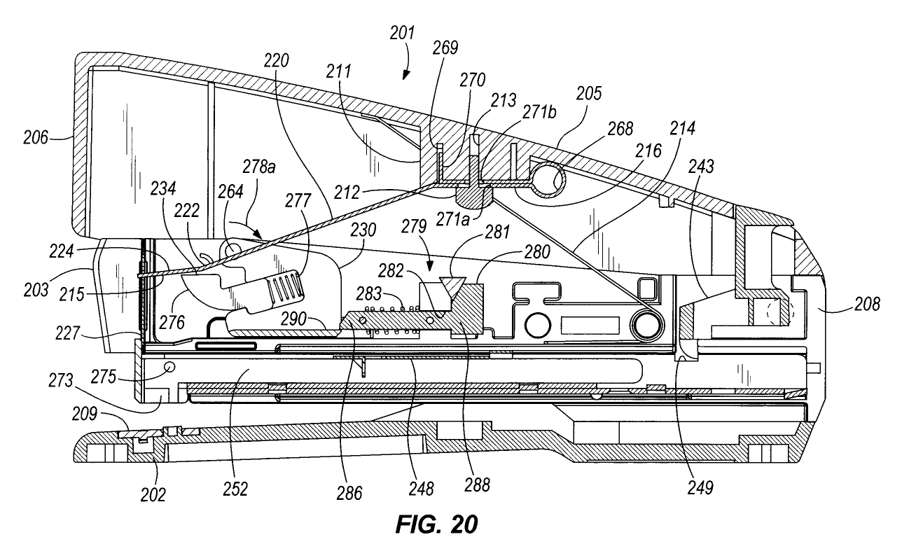

Referring to FIG. 15, the magazine 150 further includes a boss 175 formed inside of the inner rails 152. The staple pusher 148, which is biased toward the driver blade 127, contacts the boss 175 when there are no staples remaining in the magazine in order to prevent the staple pusher 148 from being located directly underneath the driver blade 127. Therefore, if the user pushes the cover 105 to eject or push out a staple when there are no staples in the magazine 150, the driver blade 127 will pass into and through the magazine 150 without generally contacting the staple pusher 148. While the boss 175 is an upstanding flange, in other constructions the boss 175 can be any suitable member, such as a protrusion formed on the inside of the inner rail 152. Such a construction is illustrated in FIGS. 20-23.

Operation of the stapler 101 of FIGS. 15-19 is generally the same as the stapler 1 of FIGS. 1-11.

FIGS. 20-22 illustrate yet another alternative embodiment of the stapler 1 of FIGS. 1-11. The stapler 201 of FIGS. 20-22 is similar to the stapler 1 of FIGS. 1-11. Therefore, like components have been given like reference numbers in the two-hundred series, and only the general differences will be discussed below.

Referring to FIG. 20, the illustrated cover biasing member 214 of the stapler 201 is a torsion spring that contacts the cover 205 at a position closer to the front end 206 of the stapler 201 than the cover biasing member 14 of the stapler 1 of FIGS. 1-11. Increasing the distance from the point that the cover biasing member 214 contacts the cover 205 to the point about which the cover rotates increase the effective length of a lever created between the point that the cover biasing member 214 contacts the cover 205 to the point about which the cover 205 rotates. As understood by one of skill in the art, the longer lever reduces the spring force needed to raise the cover 205.

The support member 230 of the stapler 201 is a cam that pivots or rotates about the axis 264. The illustrated support member 230 includes a slider member 276 and a biasing member 277 between the support member 230 and the slider member 276. The biasing member 277 biases the slider member 276 toward the front end 206 of the stapler 201. While the illustrated biasing member 277 is a coil spring, it should be understood that the biasing member can be any suitable biasing member, such as other types of springs, an elastomer, and the like.

While not visible in FIG. 20, the stapler 201 includes a support member biasing member that biases the support member 230 about the axis 264 in the direction indicated by an arrow 278a. The support biasing member can be a torsion spring or other suitable devices.

The stapler 201 further includes a support member release mechanism 279. The illustrated support member release mechanism 279 includes a release member 280 and an activation member 281. The illustrated release member 280 includes an elongated portion 286 that extends through an aperture 282 formed in the frame 203 and an enlarged portion 288 formed on an end of the elongated portion 286. The activation member 281 is located between the frame 203 and the enlarged portion 288 of the release member 280, and in the illustrated embodiment has a wedge-shaped configuration. A biasing member 283, which is a coil spring in the illustrated construction, surrounds a portion of the elongated portion 286 of the release member 280 and biases the release member 280 toward the front end 206 of the stapler 1, into engagement with the support member 230.

The illustrated support member 230 includes a release member engagement portion 290. The engagement portion 290 engages the elongated portion 286 of the release member 280 to retain the support member 230 in the position illustrated in FIG. 20. While the release member engagement portion 290 of the support member 230 is a ledge portion of the support member 230, in other constructions the engagement portion 290 can be any suitable member, such as an aperture, surface, and the like.

The operation of the stapler 201 is generally the same as the operation of the stapler 1, discussed above. Therefore, only the general differences in the operation will be discussed below.

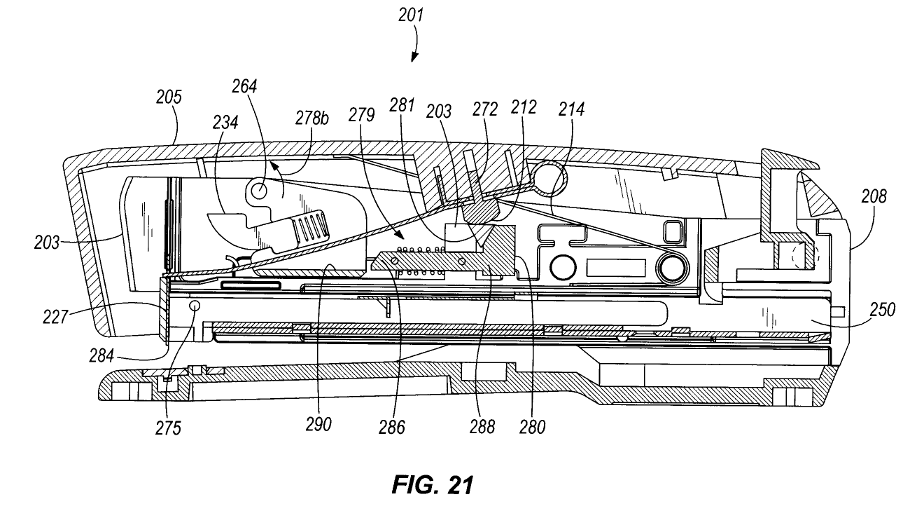

FIG. 20 illustrates the stapler 201 in the starting or original position when the stapler 201 is not being used. As discussed above with regard to FIGS. 5a-5c, as the user pushes down on the cover 205, the engagement portion 222 of the elastic member 220 moves forward or toward the front end 206 of the stapler 201. Eventually the elastic member 220 will move far enough forward that the elastic member 220 disengages from the support surface 234 of the support member 230, or the trigger mechanism 212, which is a cam in the illustrated construction, will activate the support member release mechanism 279 to release the support member 230 to ensure that the driver blade 229 and elastic member 230 will fall and drive a staple (FIG. 21).

Referring to FIG. 21, in the illustrated construction, when cover 205 is pushed down far enough the trigger member 212 contacts the activation member 281 of the support member release mechanism 279. As the cover 205 is pushed down even farther the trigger member 212 pushes the activation member 281 downward between the frame 203 and the enlarged portion 288 of the release member 280 causing the release member 280 to slide toward the rear end 208 of the stapler 201. As illustrated in FIG. 21, when the elongated portion 286 of the release member 280 moves rearward to a predetermined point, the release member 280 is removed from contact with the engagement portion 290 (e.g., an aperture, surface, etc.) of support member 230. With the release member 280 no longer contacting the support member 230, the support member 230 is free to rotate about the axis 264. The downward force of the elastic member 220 acting on the slider 276 of the support member 230 (FIG. 20) rotates the support member 230 about the axis 264 in the direction indicated by the arrow 278b, thereby ensuring that the elastic member 220 and the driver blade 229 will fall and push a staple from the magazine 250.

As illustrated in FIG. 21, the illustrated stapler 201 is constructed such that a portion 284 of the driver blade 227 extends from the magazine 250 after the driver blade 227 has been lowered to drive a staple. While only the stapler 201 of FIGS. 20-22 has been shown with the portion 275 extending from the magazine 250 after the driver blade 227 has been lowered, it should be understood that any of the staplers described herein can include such a feature.

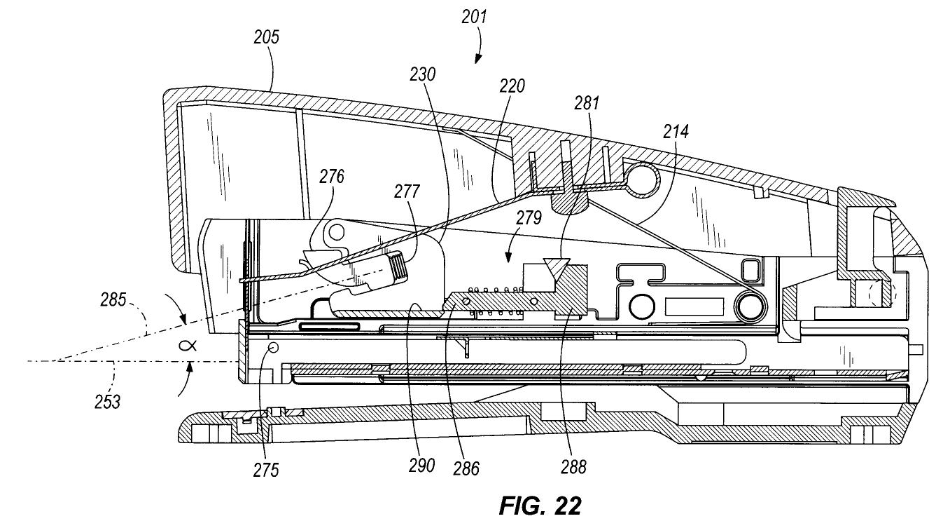

As illustrated in FIG. 22, the slider 276 of the support member 230 facilitates returning the elastic member 220 to its starting or original position. As the cover biasing member 214 forces the cover 205 and elastic member 220 upward, the cover biasing member 214 overcomes the force of the slider biasing member 277 and the elastic member 230 forces the slider 276 to slide into the support member 230 along a slider axis 285. The support member 230 is constructed such that the slider axis 285 is positioned at an angle α with respect to the magazine axis 253. In the illustrated construction, the angle α is approximately 20 degrees and in other constructions, the angle α can be any suitable angle.

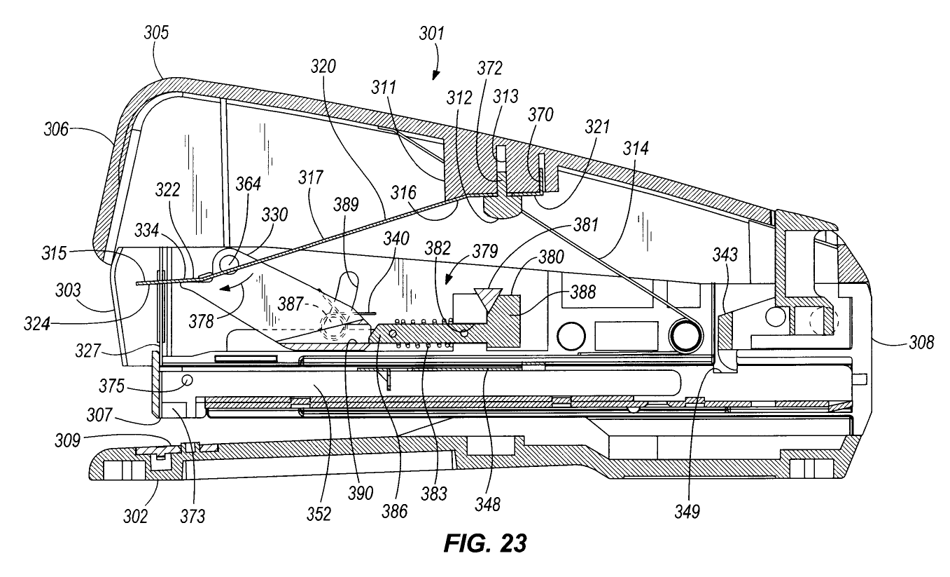

FIG. 23 illustrates an alternative construction of the stapler 201 of FIGS. 20-22. The stapler 301 of FIG. 23 is similar to the stapler 201 of FIGS. 20-22. Therefore, like components have been given like reference numbers in the three hundred series, and only the general differences will be discussed below.

The support member 330 of the stapler 301 omits the slider 276 of the stapler 201 of FIGS. 20-22. The support member 330 further includes a boss 387 that is coupled to the support member 330. The boss 387 is positioned in a slot 389 that is formed in the frame 303. The ends of the slot 389 define the maximum rotational positions of the support member 330. The illustrated support member biasing member 340 is located around the boss 387 and biases the support member 330 in the direction indicated by the arrow 378 about the axis 364. In other constructions, the support member biasing member 340 can be located at other suitable locations or in other suitable configurations.

The operation of the stapler 301 is generally the same as the operation of the stapler 201 of FIGS. 20-22 with the exception that the stapler 301 omits the slider 276 of the stapler 201.

Various features and advantages of the invention are set forth in the following claims.

What is claimed is:

1. A desktop stapler comprising:
a base configured to rest on a support surface;
a cover coupled to the base;
a magazine coupled to the base and the cover and configured to house staples;
an elastic member positioned at least partially between the cover and the magazine and that stores energy applied to the cover as the cover is moved relative to the magazine;
a driver blade coupled to an end of the elastic member and configured to push out staples from the magazine; and
a support member that selectively engages the elastic member;
wherein energy is stored in the elastic member as the cover is moved relative to the magazine and the elastic member is engaged with a portion of the support member, and wherein energy stored in the elastic member is released when the elastic member disengages from the portion of the support member, causing the driver blade to push out a staple.

2. The stapler of claim 1, wherein the support member is a slider movable in a direction parallel to a longitudinal axis of the magazine.

3. The stapler of claim 2, wherein the elastic member has an engagement portion selectively engaged with a support surface of the slider, and wherein the engagement portion moves along the support surface of the slider as the cover is moved relative to the magazine until the engagement portion disengages the support surface of the slider.

4. The stapler of claim 3, wherein the elastic member passes through a portion of the slider when the engagement portion disengages the support surface of the slider.

5. The stapler of claim 2, wherein the slider includes a tapered front end.

6. The stapler of claim 5, wherein the tapered front end is radiused.

7. The stapler of claim 2, further comprising a biasing member biasing the slider toward the driver blade.

8. The stapler of claim 2, further comprising a trigger member coupled to the cover and operable to move the slider to facilitate disengagement of the elastic member from the portion of the slider.

9. The stapler of claim 1, wherein the stapler includes a front end adjacent a staple ejection location and a rear end, and wherein the magazine is extendable from the front end of the stapler to allow a user to load staples in the magazine.

10. The stapler of claim 1, wherein the elastic member is a leaf spring.

11. The stapler of claim 10, wherein the leaf spring is formed with two layers at one end of the leaf spring.

12. The stapler of claim 1, wherein the leaf spring includes a generally T-shaped engagement portion.

13. The stapler of claim 10, wherein the driver blade extends at least partially out of the magazine when the elastic member disengages from the portion of the support member.

14. The stapler of claim 1, wherein the support member is a pivotable cam.

15. The staple of claim 14, wherein the support member includes a slider member configured to facilitate returning the elastic member to a starting position.

16. The stapler of claim 1, wherein the elastic member is in continuous engagement with the driver blade during a stapling operation.

17. A desktop stapler comprising:
a base configured to rest on a support surface;
a cover coupled to the base;
a magazine coupled to the base and the cover and configured to house staples;
a leaf spring positioned at least partially between the cover and the magazine and that stores energy applied to the cover as the cover is moved relative to the magazine, the leaf spring having at least a portion formed with two layers;
a driver blade coupled to an end of the leaf spring and configured to push out staples from the magazine; and
a support member that selectively engages the leaf spring;
wherein energy is stored in the leaf spring as the cover is moved relative to the magazine and the leaf spring is engaged with a portion of the support member, and wherein energy stored in the leaf spring is released when the leaf spring disengages from the portion of the support member, causing the driver blade to push out a staple.

18. The stapler of claim 17, wherein the portion of the leaf spring formed with two layers includes a loop.

19. The stapler of claim 17, wherein the leaf spring is connected to the cover at the portion of the leaf spring having two layers.

20. The stapler of claim 17, wherein one of the two layers of the leaf spring includes an aperture having a first size and the other of the two layers includes an adjacent aperture having a second size that is larger than the first size.

21. The stapler of claim 17, wherein one of the two layers of the leaf spring includes a tab received in a slot formed in the cover.
